(19) United States
(12) Patent Application Publication
(10) Pub. No.: US 2023/0219824 A1
(43) Pub. Date: Jul. 13, 2023

(54) CALCIUM LANTHANUM SULFIDE NANO-POWDERS, METHOD OF MAKING, AND OPTICALLY TRANSMISSIVE BODY FORMED THEREFROM

(71) Applicant: Venkata S Reddy Channu, Ann Arbor, MI (US)

(72) Inventor: Venkata S Reddy Channu, Ann Arbor, MI (US)

(21) Appl. No.: 17/739,769

(22) Filed: May 9, 2022

Related U.S. Application Data
(60) Provisional application No. 63/298,608, filed on Jan. 11, 2022.

(51) Int. Cl. C01F 17/38; C04B 35/547

(52) U.S. Cl. CPC C01F 17/38; C04B 35/547; C04B 35/62884

(57) ABSTRACT

A method for producing calcium lanthanum sulfide (CLS) nano powder and optical ceramics formed therefrom. The method includes the steps of mixing a lanthanum precursor and calcium precursor in water to obtain a solution and adding a sulfide precursor to the solution. Upon adding the sulfide precursor, stirring the solution for 5-25 minutes at 55-95° C. to obtain a mixture. The mixture is then introduced into a muffle furnace, preheated at 400-600° C., and the mixture is kept for 15-50 minutes to obtain nano powder. The nano powder can be annealed and subjected to spark plasma sintering to obtain the optical ceramics.

### CROSS-REFERENCE TO RELATED APPLICATIONS

This application claims priority from the U.S. provisional patent application Ser. No. 63/298,608, filed on Jan. 11, 2022, which is incorporated herein by reference in its entirety.

### FIELD OF INVENTION

The present invention relates to infrared-transmitting materials, and more particularly, relates to the synthesis of calcium lanthanum sulfide powders, and making an optically transmissive body therefrom.

### BACKGROUND

The development of infrared-transmitting materials started in the mid-1950s′ as a response to the growing demand for military and commercial instruments with improved optical and mechanical properties, especially the newly developed “heat seeking” missiles. The optical windows and domes employed in “heat seeking” missile systems for infrared imaging demand good mechanical stability and high optical transmission in the wavelength range between 0.5-14 microns. These mechanical and optical properties should be preserved when these windows are exposed to hostile environments. The demands placed on the performance of the windows finally depend on the nature of the materials used for the windows and the processes the materials undergo. Typically, materials that offer the best mechanical durability and optical performance for infrared imaging systems, employed in windows and domes of missile systems, particularly in the wavelength range of 0.4-14 microns in the infrared band, are limited to a small number of materials. Suitable materials include zinc sulfide, zinc selenide, germanium, gallium arsenide, gallium phosphide, mercury cadmium telluride, and cadmium telluride. Zinc sulfide (ZnS) is the most suitable of the present infrared window materials, especially for its performance at elevated temperatures. However, ZnS optics, currently available as chemical-vapor-deposited (CVD) polycrystalline materials, have poor resistance to erosion by rain and sand or dust particles, and require durable protective coatings for external use, all which increases the cost multiple times.

In the early-1980s′, compounds of the CaLa₂S₄—La₂S₃ solid solution system (CLS) emerged as alternative window materials to CVD ZnS, based on their superior mechanical properties, better erosion resistance, and longer transmission in the long-wave infrared (LWIR) window up to 14 μm. A higher domain of transparency in the infrared significantly improves the performance of the infrared optical systems and allows the use of uncooled detectors (operate beyond 12 μm), resulting in a significant reduction in system cost. Two chemical routes (Evaporative Decomposition of Solution and precipitation) were proposed for the preparation of the precursor powder, but the development of the ceramics never arrived at commercial maturity. Indeed, the reproducibility of the optical properties of the sintered materials remained a problem that was thought to be a result of the variability of the powder caused or increased by lengthy and complicated processes. For both methods, the sole sulfurization step of the precursors required times up to several days.

Calcium lanthanum sulfide is also well suited for use in dual-band sensors. Introducing CLS into the imaging system reduces the number of elements required to meet diffraction limited optical performance and sensor complexity. Because of the limited number of materials which transmit in the mid-wave infrared (MWIR) and LWIR, the improved CLS material properties may directly reduce the chromatic aberration in the optical systems.

Thus, a need is appreciated for a cost-effective processing route to produce calcium lanthanum sulfide nano powders, and a method for forming optically transmissive windows therefrom.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a cost-effective processing route to produce calcium lanthanum sulfide.

It is still another object of the present invention to form optical polycrystalline ceramic windows from calcium lanthanum sulfide powder.

It is a further object of the present invention that the windows have high mechanical strength.

It is still a further object of the present invention that the windows can withstand high-velocity rain-erosion.

It is an additional object of the present invention that the yield of calcium lanthanum sulfide powders is improved significantly.

It is still an additional object of the present invention that the optically transmissive body has high mechanical strength.

It is yet an additional object of the present invention that the optically transmissive body has high optical transmission in the visible and infrared portions of the electromagnetic spectrum.

In one aspect, disclosed is a cost-effective processing route to produce calcium lanthanum sulfide (CLS), CaLa₂S₄, via a novel fast fabrication (combustion synthesis) of precursor powders.

In one aspect, disclosed is a process of forming nanocrystalline optical ceramics, as infrared transmissive bodies from the CLS nano powders by spark plasma treatment of CLS nano-sized crystalline particles under high pressure and temperature.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a graph showing an XRD pattern of combustion synthesized CLS nano powder, according to an exemplary embodiment of the present invention.

FIG. 2 shows a SEM image of the CLS nano powder, according to an exemplary embodiment of the present invention.

FIG. 3 is a TGA curve of combustion synthesized CLS nano powder, according to an exemplary embodiment of the present invention.

FIG. 4 is an FTIR spectra of the combustion synthesized CLS nano powder, according to an exemplary embodiment of the present invention.

FIG. 5 shows a typical spark plasma chamber for the process of spark plasma treatment (SPS) or Field Assisted Sintering Technique (FAST), according to an exemplary embodiment of the present invention.

FIG. 6 is a Scanning Electron Micrograph (SEM) image of ultra-high density of cubic CLS that underwent the spark plasma treatment, according to an exemplary embodiment of the present invention.

FIG. 7a shows an optical disc prepared from CLS nano-powder by SPS method, according to an exemplary embodiment of the present invention.

FIG. 7b shows the optical disc as in FIG. 7a sintered at a different temperature, according to an exemplary embodiment of the present invention.

FIG. 8a shows an optical transmittance spectra of the optical disc of FIG. 7a, according to an exemplary embodiment of the present invention.

FIG. 8b shows an optical transmittance spectra of the optical disc of FIG. 7b, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

Disclosed is a process for producing calcium lanthanum sulfide (CLS), CaLa₂S₄ nano powders. More particularly, disclosed is cost-effective processing route to produce calcium lanthanum sulfide via a novel fast fabrication (combustion synthesis) of precursor powders without the addition of polymers, amino acids, or stabilizer agents to control particle sizes. Also, disclosed is a process of forming nanocrystalline optical ceramics, as infrared transmissive bodies from the CLS nano powders. Disclosed is a process of forming nanocrystalline optical ceramics by spark plasma treatment of CLS nano-sized crystalline particles under high pressure and temperature. The disclosed method and processes offer an exceptionally reliable route for the manufacture of ultra-highly pure CLS nano powders, having high surface area of about 50-80 m²/g which is necessary to produce high strength durable optical ceramics. Moreover, the high surface area of CLS nano powders may enable high IR transmission over 6-16 microns range via Spark Plasma Sintering, Hot Pressing and Hot Isostatic Pressing at modest temperatures and times. Additionally, the disclosed methods and processes allow for precise particle size control by fine-tuning the reaction time, temperature, pH, and speed of the stirrer during the reaction phase. The disclosed methods and processes are fast, inexpensive, and environmentally benign synthesis processes.

In certain implementations, disclosed is a novel combustion method for producing CLS nano-sized crystalline particles The CLS can be prepared from starting materials that include metal (Ca, La) sources and sulfide sources. The metal (Ca, La) sources/precursors can be selected from groups that include calcium and lanthanum nitrates, calcium and lanthanum chlorides, calcium and lanthanum acetate anhydrous, and calcium and lanthanum carbonate. The sulfide sources/precursors can be selected from groups that include sodium thiosulfate, thioacetamide, thiourea, sodium sulfide, ammonium sulfide, lithium sulfide, potassium sulfide, and hydrogen sulfide.

### Example 1: Production of CLS Powders by Combustion Method

CLS (La/Ca=2.3 and 2.7) powders were prepared using a solution combustion method. The starting reagents, lanthanum nitrate hexahydrate La(NO₃)₃·6H₂O (Alfa Aesar, 99.99%), and hydrated calcium nitrate Ca(NO₃)₂·4H₂O (Alfa Aesar, 99.99%) were dissolved in distilled water. To this solution, thioacetamide CH₃CSNH₂ (Alfa Aesar, 99%, ACS Reagent) was added and then stirred for 5-25 minutes at 55-95° C. The mixture was then introduced into a muffle furnace preheated to 400-600° C. and held for 15-50 minutes at this temperature. After completion of combustion step, powder was placed in a desiccator to prevent areal oxidation. The combustion synthesized CLS powder was annealed in the tube furnace for 4-9 hours under 90% H₂S/10% N₂ gas flow at 900-1300° C. Polycrystalline Pr³⁺ doped CaLa_{2.7}S_{4.6} was synthesized by the combustion method, Praseodymium(III) Nitrate Hexahydrate (Pr(NO₃)₃·6H₂O) was used as the Pr′ source. Table 1 shows the optimized conditions for synthesis of CLS nano powders.

TABLE 1
Conditions used for combustion method:

| | | | DI | | |
|---|---|---|---|---|---|
| | Time | Precursor Chemical | H2O | Results | |
| No. | (min) | used | (ml) | SEM | XRD |
| #10C | 20-25 | Ca(NO₃)₂ · 4H₂O, | 400 | Nano | Pure |
| | | La (NO₃)₃ · 6H₂O), | | powders | CLS |
| | | thiourea | | | |
| #16C | 35-45 | Ca(NO₃)₂ · 4H₂O, | 600 | Nano | Pure |
| | | La (NO₃)₃ · 6H₂O), | | powders | CLS |
| | | thioacetamide | | | |
| #25C | 30-35 | Ca(NO₃)₂ · 4H₂O, | 500 | Nano | Pure |
| | | La (NO₃)₃ · 6H₂O), | | | CLS |
| | | thioacetamide | | powders | |
| #28C | 35-40 | Ca(NO₃)₂ · 4H₂O, | 500 | Nano | 90% |
| | | La (NO₃)₃ · 6H₂O), | | powders | CLS |
| | | thioacetamide, | | | |
| | | (Pr(NO₃)₃ · 6H₂O) | | | |

### Example 2: Characterization of the CLS Nanoparticles

The samples were characterized using the following methods: 1. Powder X-ray diffraction, 2. Scanning Electron Microscopy & EDAX, 3. Thermogravimetric Analysis, 4. BET surface area measurements, 5. Glow discharge mass spectrometry, 6. X-ray Photo Electron Spectroscopy (ESCA), 7. Consolidation of CLS nanoparticles to full density >99% (Nanograin structures).

### Powder X-Ray Diffraction

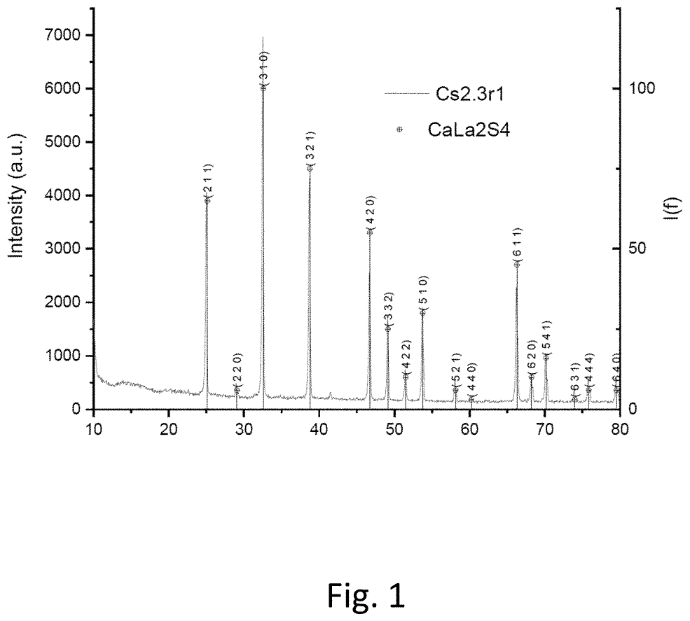

The combustion synthesized samples from Experiments #25C and #28C (Table 1) were characterized by X-ray diffraction. The XRD patterns of CLS show the presence of intense reflection peaks corresponding to the “CLS” crystal structure. The ICDD card #00-29-0339 exactly matches the powder X-ray diffraction pattern. FIG. 1 shows XRD pattern of CLS nano powder from Experiment #25C.

### Scanning Electron Microscopy:

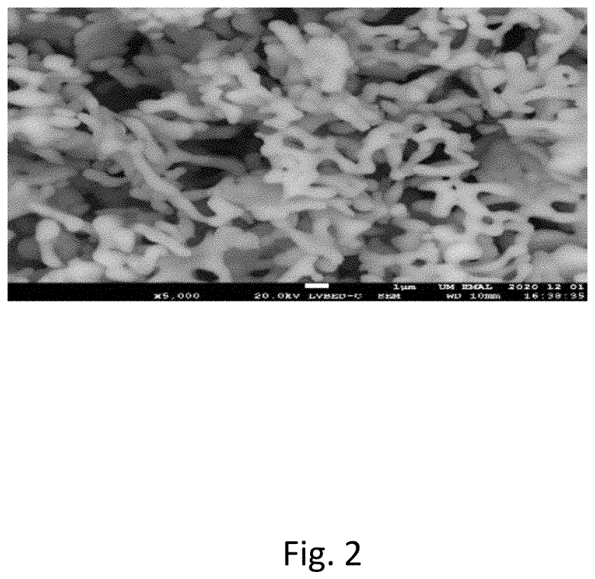

JEOL-JSM-6360A, JEOL-JSM-7500F, and Quanta FE-600 scanning electron microscopes (SEM) were used in the analysis of CLS nanoparticle samples. A typical scanning electron microscope (SEM) image of the sample #25C (Table 1) is presented in FIG. 2, in which the morphology of nanoparticles is also clearly visible. The particles sizes are ˜400 nm for sample no. #25C.

### Thermogravimetric Analysis:

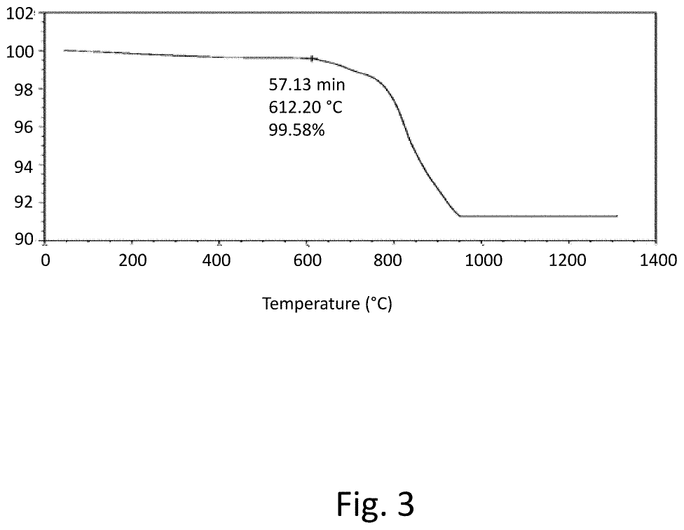

The Thermogravimetric Analysis (TGA) curve of combustion synthesized powder #25C in Table 1 was annealed at 1000° C. for 3-5 hours in 90% H₂S/10% N₂ gas is shown in FIG. 3. The initial weight loss is 0.42% from room temperature to 612° C., which corresponds to the evaporation of water from the surface of the powder.

### BET Surface Area Analysis:

The Brunauer, Emmett, and Teller Method surface area of the powders was analyzed by nitrogen adsorption in a Quantachrome Nova-4200E model surface area analyzer nitrogen adsorption apparatus (USA). All samples were degassed at 100° C. prior to nitrogen adsorption measurements.

TABLE 2
shows the surface area of the optimized nano CLS samples.

| | Sample | SBET | | |
|---|---|---|---|---|
| S. No | ID | (m²/g) | X-ray | SEM |
| 1 | #25C | 81.30 | Single phase | Particle Sizes ~300 nm |
| | | | CLS | |
| 2 | #28C | 84.40 | 90% Single | Particle Sizes ~200 nm |
| | | | phase CLS | |

### FTIR Analysis

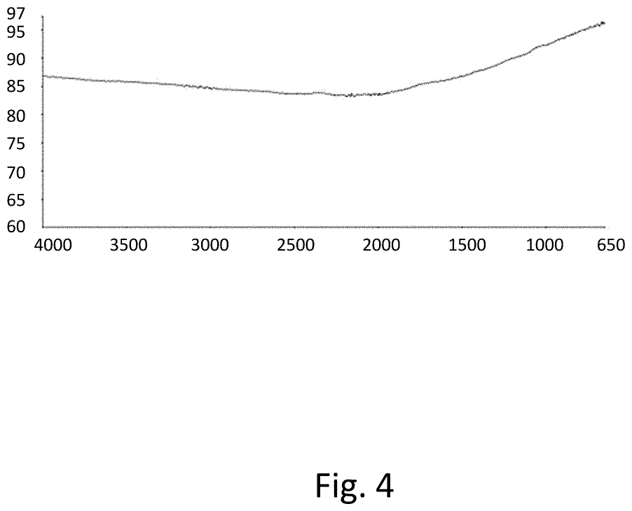

FTIR spectra was recorded from 4000-600 cm⁻¹ with eight scans of 4 cm⁻¹ resolution on prepared materials. FIG. 4 shows the FTIR spectra.

### Example 3: SPS Sintering

Prior to undergoing the spark plasma treatment, the samples of CLS were subjected to powder X-ray diffraction (XRD) and Scanning Electron Microscopy (SEM) analysis to confirm the phase purity of the CLS and the morphology of the nano-size particles. The powder X-ray diffraction is done by placing the powder samples on to a glass slide and subjected to X-ray analysis. The XRD patterns of CLS show the presence of broad reflection peaks indicating nanostructures and corresponding to the cubic “CLS” crystal structure. SEM analysis shows spherical particles of size ˜200-300 nm.

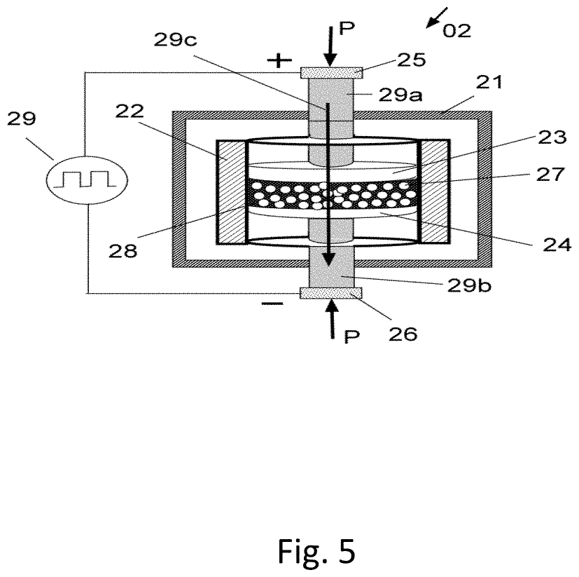

Referring to FIG. 5 which shows a typical spark plasma chamber for the process of spark plasma treatment or Field Assisted Sintering Technique (FAST). The electrodes 25 and 26 are connected to a pulse DC current source 29. The space between the top punch 23 and the bottom punch 24, called the active chamber, is filled with nano-size crystalline particles 27 (CLS nano powder). The spark plasma 28 is created between the particles intermittently according to the pulsating current supplied by the current source 29. The main plasma current 29c flows from the anode electrode 25 to the cathode 26. Pressure P is applied continuously to the top punch 23 and the bottom punch 24 through the punch holder 29a and 29b. The active plasma chamber is kept at an elevated temperature. For the sake of simplicity, the heat control and hydraulic pressure mechanisms are omitted in FIG. 5.

Nano-size particles of crystalline CLS were sintered using the spark plasma apparatus shown in FIG. 5. Prior to heating the active chamber containing the particles, evacuation is done, and Argon gas is used to flush out the inside of the active chamber and the space between chambers 21 and 22. For the sake of simplicity, the vacuum system, Argon injection and heat control systems are not shown in FIG. 5. The heating of the active chamber is done at the rate in the range of 600-900° C./min to a temperature in the range of 750-900° C. A pressure in the range of 70-120 Pa is applied to the top punch 23 and bottom punch 24.

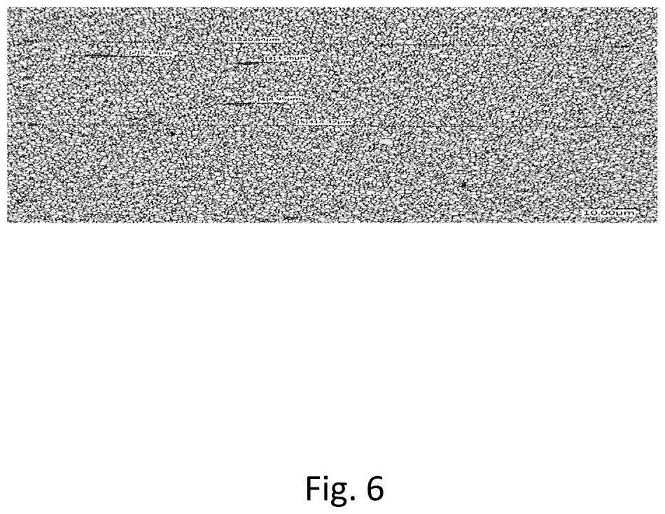

The active chamber, the space between the top punch 23 and the bottom punch 24, is further heated to reach a temperature in the range of 900-1050° C. A vacuum of 10 Pa is maintained in the active chamber. Voltage pulses are applied at these conditions between electrodes 25 and 26. This creates ‘spark plasma’ in the space between the particles. The plasma current is controlled by the current source 29 which initiated the voltage pulses. This plasma creates filamentary currents at a high density around the particles making them melt and undergo ‘grain-welding’ (sintering) to take place between the particles. Since the spark plasma creates high current density momentarily around the particles, introducing joule heating the core of the particles are not substantially affected. This phenomenon prevents substantial growth of the grain size. The intermittent spark plasma is done for a duration in the range of 1-5 minutes. The power is turned off after this treatment. The nano-grains ranging from 500-700 nm can be seen in the micrograph. The spark plasma treated CLS will exhibit high mechanical strength but can be optically less transmissive. The optical transmission can be improved, both in visible wavelengths as well as in infrared wavelengths in the range of 0.5-14 microns, through a thermal annealing step. FIG. 6 shows the Scanning Electron Micrograph image of ultra-high density of cubic CLS that underwent the spark plasma treatment

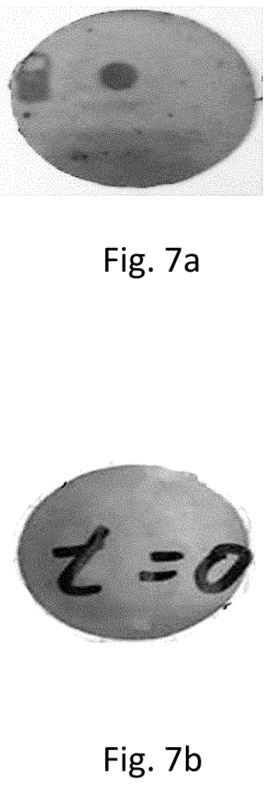

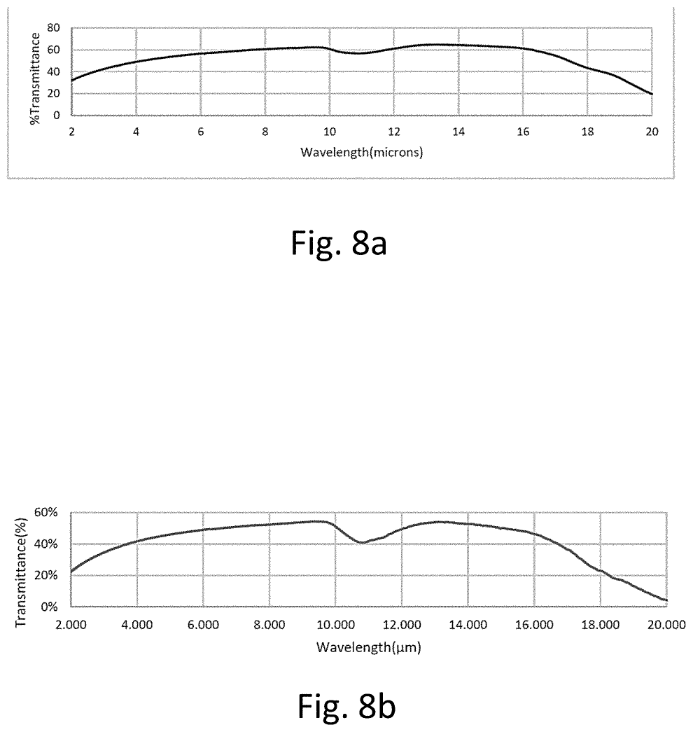

Using the above sintering process, CLS nano powders prepared by the combustion methods were consolidated into disks of 20 mm diameter×2 mm thick samples. FIG. 7a shows the disk prepared from sample CLS powder #25C (Table 1) at 1100° C., and FIG. 7b shows the disk prepared from sample CLS powder #28C (Table 1) at 1125° C.

The process of ultra-high densification of CLS obtained through spark plasma treatment as described in the foregoing paragraphs is just one example. This process can be applied for many materials such as ZnS, CaS, SrS, PbS, CaF₂, SrF₂, ZnF₂, Ga₂S₃, Zinc selenide, Gallium phosphide, spinel (MgAl₂O₄, Magnesium Aluminum Oxide) and aluminum oxynitride (ALON) can also be used. The sintered and annealed ceramic windows of this invention can be supplemented with coatings to further enhance their properties and provide increased protection. An anti-reflective coating, for example, can be applied to minimize the reflection of infrared radiation and thereby cause more of the radiation to pass through the window. Examples of coating materials for this purpose are low refractive index materials, particularly yttria, silica, magnesium fluoride, calcium fluoride, zinc fluoride, zinc selenide, and hafnium oxide. Multiple anti-reflective coatings can also be used. In some applications, a coating that will transmit visible radiation in addition to the infrared radiation may be desired. Examples of coating materials for this purpose are leaded glass and zinc selenide. Alternatively, or in addition, coatings for scratch or erosion resistance can be applied, particularly for enhanced protection against rain, blowing sand, and particle impacts in general. Materials with a high damage threshold velocity such as gallium phosphide, sapphire, spinel, and aluminum oxynitride (ALON) can also be used.

Thus, the novel technique of ultra-high densification of nano-size crystals of CLS through spark plasma treatment under high pressure and temperature, followed by thermal annealing, results in high mechanical strength and high transmission of CLS for use in windows and domes employed in missile systems for infrared imaging. This novel technique can be applied to other materials listed above and these materials can be used in various applications where, both mechanical strength and optical transmission are important to be stable against hostile environment.

In certain implementations, the effect of sintering additives to reduce grain growth during sintering to produce nano-grain optical ceramics was also demonstrated. It was found that Refractory oxide additives produced a superior sintered product that has high mechanical strength, high transparency, and superior IR optical between 6-16 μm in comparison to the current CLS product.

Besides the SPS sintering, the other processes including the Hot press and Hot isostatic press (HIP) were also investigated. Hot pressing was carried out under dynamic vacuum (about 0.2 mbar) using VAS equipment. A typical quantity of 8 g of combustion synthesized CLS powder was introduced in a 25 mm diameter graphite die coated beforehand with boron nitride (BN) to facilitate demolding. Combustion synthesized powders were sintered at 1100° C., 1150° C., and 1200° C. with a heating rate of 10° C./min. A load of 90 MPa (maximum pressure allowed on HP die) was applied at the selected sintering temperature (1100-1200° C.) for 6 hours. At the end of the dwell time, the pressure was released, and samples were cooled naturally. Graphite grade used in Hot press (HP) experiments was selected to optimize the compressive strength. Also, HP dies were designed for the use of BN coating while SPS dies were designed for the use of graphite foil. The sintered disks were polished down to about 0.90-0.94 mm thickness. The optical transmittance was measured by FTIR.

In the Hot isostatic press (HIP), CaLa₂S₄ and Pr-doped CLS powders synthesized by combustion method were used for HIP experiments. The powders were pressed to 2.00 cm diameter pellets first in a double acting steel die, followed by cold isostatic press at 200 MPa followed by annealed at 1000° C. for 6 hours in Argon atmosphere. Hot Isostatic Pressing was carried out in an Alumina Crucible by folding disks in Pt foil at 1100° C., 200 MPa for 1 h under flowing Argon atmosphere.

TABLE 3
The bulk density of CLS disks densified by different methods:

| | | | | Bulk | Theoretical | Relative |
|---|---|---|---|---|---|---|
| | Synthesis of | Densification | Sintering Temp. | Density | Density | Density |
| Disk | powder | Method | (° C.) | g/cm³ | g/cm³ | (%) |
| 4 | Combustion | SPS | 1000-1200 | 4.510 | 4.574 | 98.6 |
| | Sample #25C | | | | | |
| 7 | Combustion | SPS | 1025-1225 | 4.450 | 4.574 | 97.3 |
| | Sample #25C | | | | | |
| 8 | Combustion | Hot Press | 1000-1200 | 4.535 | 4.574 | 99.1 |
| | Sample #25C | | | | | |
| 9 | Combustion | Hot Press | 1050-1250 | 4.537 | 4.574 | 99.2 |
| | Sample #25C | | | | | |
| 10 | Combustion | Hot Press | 1000-1200 | 4.545 | 4.574 | 99.4 |
| | Sample #25C | | | | | |
| 21-017 | Combustion | HIP | 1000-1200 | 4.562 | 4.574 | 99.7 |
| | Sample #25C | | | | | |
| 20-540 | Combustion | HIP | 1000-1200 | 4.599 | 4.62 | 99.5 |
| | Sample #28C | | | | | |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for forming optical ceramics, the method comprising the steps of:
mixing a lanthanum precursor and a calcium precursor in water to obtain a solution;
adding a sulfide precursor to the solution;
upon adding the sulfide precursor, stirring the solution for 5-25 minutes at 55-95° C. to obtain a mixture; and
introducing the mixture into a preheated muffle furnace, wherein the muffle furnace is preheated at 400-600° C., and mixture is kept in the preheated muffle furnace for 15-50 minutes to obtain calcium lanthanum sulfide (CLS) nano powder.

2. The method according to claim 1, wherein the method further comprises the steps of:
annealing the CLS nano powder in a tube furnace for 4-9 hours under H₂S/N₂ gas flow at 900-1300° C.

3. The method according to claim 2, wherein the method further comprises the steps of:
subjecting the annealed powder to spark plasma sintering obtaining the optical ceramics.

4. The method according to claim 3, wherein the lanthanum precursor is selected from a group consisting of Lanthanum nitrates, Lanthanum chlorides, Lanthanum Acetates, and Lanthanum carbonates.

5. The method according to claim 4, wherein the calcium precursor is selected from a group consisting of Calcium Nitrates, Calcium Chlorides, Calcium Acetates, and Calcium Carbonates.

6. The method according to claim 5, wherein the sulfide precursor is selected from a group consisting of Sodium Thiosulfate, Thioacetamide, Thiourea, Sodium Sulfide, Ammonium Sulfide, Lithium Sulfide, Potassium Sulfide, and Hydrogen Sulfide.

7. The method according to claim 3, wherein the lanthanum precursor is lanthanum nitrate hexahydrate, the sulfide precursor is thioacetamide, and the calcium precursor is hydrated calcium nitrate.

8. An optical ceramics formed by a method comprising the steps of:
mixing a lanthanum precursor and a calcium precursor in water to obtain a solution;
adding a sulfide precursor to the solution;
upon adding the sulfide precursor, stirring the solution for 5-25 minutes at 55-95° C. to obtain a mixture; and
introducing the mixture into a preheated muffle furnace, wherein the muffle furnace is preheated at 400-600° C., and mixture is kept in the preheated muffle furnace for 15-50 minutes to obtain calcium lanthanum sulfide (CLS) nano powder.

9. The optical ceramics according to claim 8, wherein the method further comprises the steps of:
annealing the CLS nano powder in a tube furnace for 4-9 hours under H₂S/N₂ gas flow at 900-1300° C.

10. The optical ceramics according to claim 9, wherein the method further comprises the steps of:
subjecting the annealed powder to spark plasma sintering obtaining the optical ceramics.

11. The optical ceramics according to claim 10, wherein the lanthanum precursor is selected from a group consisting of Lanthanum nitrates, Lanthanum chlorides, Lanthanum Acetates, and Lanthanum carbonates.

12. The optical ceramics according to claim 11, wherein the calcium precursor is selected from a group consisting of Calcium Nitrates, Calcium Chlorides, Calcium Acetates, and Calcium Carbonates.

13. The optical ceramics according to claim 12, wherein the sulfide precursor is selected from a group consisting of Sodium Thiosulfate, Thioacetamide, Thiourea, Sodium Sulfide, Ammonium Sulfide, Lithium Sulfide, Potassium Sulfide, and Hydrogen Sulfide.

14. The optical ceramics according to claim 3, wherein the lanthanum precursor is lanthanum nitrate hexahydrate, the sulfide precursor is thioacetamide, and the calcium precursor is hydrated calcium nitrate.

15. A method for producing calcium lanthanum sulfide (CLS) nano powder, the method comprising the steps of:
mixing a lanthanum precursor and a calcium precursor in water to obtain a solution;
adding a sulfide precursor to the solution;
upon adding the sulfide precursor, stirring the solution for 5-25 minutes at 55-95° C. to obtain a mixture; and
introducing the mixture into a preheated muffle furnace, wherein the muffle furnace is preheated at 400-600° C., and mixture is kept in the preheated muffle furnace for 15-50 minutes to obtain the calcium lanthanum sulfide (CLS) nano powder.

16. The method according to claim 15, wherein the method further comprises the steps of:
annealing the CLS nano powder in a tube furnace for 4-9 hours under H₂S/N₂ gas flow at 900-1300° C.

17. The method according to claim 16, wherein the lanthanum precursor is selected from a group consisting of Lanthanum nitrates, Lanthanum chlorides, Lanthanum Acetates, and Lanthanum carbonates.

18. The method according to claim 17, wherein the calcium precursor is selected from a group consisting of Calcium Nitrates, Calcium Chlorides, Calcium Acetates, and Calcium Carbonates.

19. The method according to claim 18, wherein the sulfide precursor is selected from a group consisting of Sodium Thiosulfate, Thioacetamide, Thiourea, Sodium Sulfide, Ammonium Sulfide, Lithium Sulfide, Potassium Sulfide, and Hydrogen Sulfide.

20. The method according to claim 20, wherein the lanthanum precursor is lanthanum nitrate hexahydrate, the sulfide precursor is thioacetamide, and the calcium precursor is hydrated calcium nitrate.
